(19) United States
(12) Patent Application Publication
(10) Pub. No.: US 2013/0213487 A1
(43) Pub. Date: Aug. 22, 2013

(54) PIPELINE HEATING TECHNOLOGY

(71) Applicants: Yuzhi Qu, Hong Kong (CN); Ki Chan, Hong Kong (CN)

(72) Inventors: Yuzhi Qu, Hong Kong (CN); Ki Chan, Hong Kong (CN)

(21) Appl. No.: 13/404,812

(22) Filed: Feb. 24, 2012

(30) Foreign Application Priority Data
Feb. 22, 2012 (EP) 12156504.8

(51) Int. Cl. F17D 1/18; F16L 53/00

(52) U.S. Cl. 137/13; 138/33

(57) ABSTRACT

An apparatus including a transfer conduit having a length and an opening therethrough; at least one thermally conductive compartment coupled to an exterior surface of the transfer conduit, the at least one thermally conductive compartment having a length dimension that extends over a portion of the length of the transfer conduit; a heating element disposed in a portion of the at least one thermally conductive compartment; and a thermally conducting material disposed in the thermally conductive compartment. A method including transferring a fluid through a transfer conduit including at least one thermally conductive compartment coupled to an exterior surface thereof, the at least one thermally conductive compartment including a heating element and a thermally conducting material disposed therein; and providing a power source to the heating element sufficient to increase the temperature of the thermally conductive compartment.

### BACKGROUND

Pipeline transport is the transportation or moving of material through a pipe. Generally, the material involves liquids and gases. Examples include oil, natural gas, biofuels, plastics, water, beverages (e.g., milk) and pharmaceuticals. Such transport may be confined to a processing and manufacturing facility or may extend distances, for example, from a production facility or a manufacturing facility to a distribution facility. Thus, pipelines may extend several feet to several hundreds of miles.

One concern in pipeline transport is the temperature of the material being transported. Pipeline heating is a common requirement in many industrial processes, including petroleum, plastics, chemicals, pharmaceuticals, power generation and food processing. Pipeline heating also extends to the transport of materials from a production or processing facility to a point of view for further processing.

One example of pipeline transport and the need for pipeline heating is crude oil transport. Crude oil recovered by an extraction well is pumped above ground and transported by pipelines to an on- or offshore station for further processing. The pipelines have a typical diameter between about 6 inches (about 152 millimeters (mm)) and about 12 inches (about 305 mm). Crude oil leaves the extraction well at a temperature on the order of about typically 125-175° C. At these temperatures the crude oil is fluid and can be pumped. However, above ground the pipeline may be exposed to temperature of only a few degrees Celsius, for example about 5° C. for pipelines at low sea floor levels. Onshore pipelines in Canada, Alaska or Siberia are exposed to even lower temperatures (about −40° C.). At these low temperatures the viscosity of the crude oil raises and some components of the crude oil like paraffin or methane hydrate tend to solidify and to attach thereby to the pipeline, reducing its free diameter until the pipeline is blocked.

Pipeline heating applications, commonly referred to a heat tracing systems, provide heat to prevent pipeline freezing to replace process heat loss and to maintain any viscosity of the material being transported. Different pipeline heating techniques have been proposed. For example, a pipeline may be heated by applying a current through the pipeline (resistive heating) like suggested in U.S. Pat. No. 6,509,557 or by attaching electrical heating pads to the pipeline. Alternatively, the pipeline may have two concentric ducts. The inner duct is for the crude oil and the outer duct is for some heated liquid like hot water, steam or the like. DE 10-2008-056 257 discloses an inductive pipeline heating.

### SUMMARY

In one embodiment, a pipeline apparatus include at least, a pipe or duct for transportation of a material, such as crude oil, at least one thermally conductive compartment connected to the pipe or duct and longitudinally extending parallel to the pipe and at least one electrical heating element within the at least one thermally conductive compartment. Commercially available heating cartridges may be used for the heating element. In one embodiment, such cartridges can be replaced easily through, for example, a releasable end cap or an opening in the end cap associated with the compartment. The thermally conductive compartment, being attached to the pipe or duct, may also serve to reinforce the pipe or duct.

Preferably the at least one thermally conductive compartment contains a composition of inorganic compounds and possibly pure elemental species. Examples for such a composition are described in U.S. Pat. Nos. 6,132,823, 6,911,231, 6,916,430, 6,811,720 and U.S. Publication No. 2005/0056807, which are incorporated by reference as if fully disclosed herein. Such composition acts as a thermally conductive material or medium to provide at least an almost perfect homogenous distribution of the heat provided by the heater cartridge. The thermally conductive compartment may as well be evacuated as suggested in the above references. Generally, the thermally conductive compartment and the contents thereof act as a heatpipe.

In one embodiment, the dimensions of the thermally conductive compartment are selected to provide a chamber that includes a gap between the heating cartridge and the pipe or duct. Such a gap tends to enhance the uniform heat distribution.

The pipeline apparatus, in one embodiment, includes a thermally insulating shell, to thereby reduce thermal losses of the pipeline apparatus.

In one embodiment, the pipeline apparatus has at least two thermally conductive compartments, for example, attached symmetrically with respect to the center of the pipe or duct. For example, there may be two thermally conductive compartments at opposed areas of the lateral area of the pipe or duct. In each of the at least two thermally conductive compartments is at least one heating cartridge. This permits a better heat distribution.

A pipeline transport system incorporating at least one pipeline apparatus is also disclosed as is a method of heating a material in a pipeline.

### BRIEF DESCRIPTION OF THE DRAWINGS

FIG. 1 is a schematic side perspective view of a system including a transfer conduit.

FIG. 2 is a cross-sectional side view of an embodiment of a pipeline apparatus of the system of FIG. 1.

FIG. 3 is a cross-sectional side view of the pipeline apparatus of FIG. 2 through line 3-3′.

FIG. 4 is a cross-sectional side view of another embodiment of a pipeline apparatus.

FIG. 5 is a cross-sectional side view of the pipeline apparatus of FIG. 4 through line 5-5′.

FIG. 6 is a partially transparent isometric top side view of another embodiment of a pipeline apparatus.

FIG. 7 is a cross-sectional side view of an embodiment of the pipeline apparatus of FIG. 6.

FIG. 8 is a magnified portion of a sleeve section of a compartment shown in FIG. 7.

FIG. 9 is a cross-sectional side view through line 9-9′ in FIG. 8.

### DETAILED DESCRIPTION

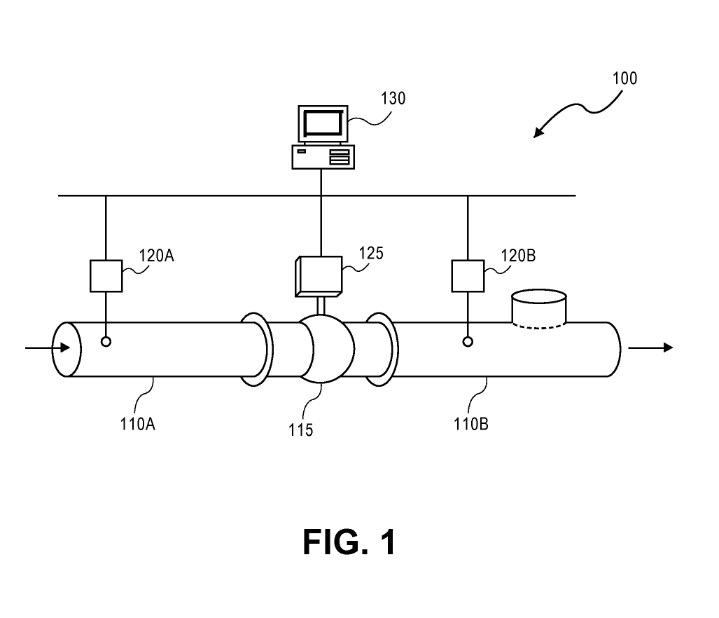

FIG. 1 shows an embodiment of a pipeline transport system. System 100 may be used, for example, in a manufacturing or production facility, such as a chemical, petroleum, pharmaceutical, or food processing or manufacturing facility or may be part of a transport system for the transport of material (e.g., crude oil, petroleum, natural gas, or beverage) from one point to another point, such as primary production and manufacturing facility to a distribution center. In this representative example, system 100 includes pipeline apparatus 110A connected to pipeline apparatus 110B through valve 115. Pipeline apparatus 110A and pipeline apparatus 110B each include a pipe or duct defining a conduit through which material may be transported. An inside diameter may range, as necessary, for the particular purpose for which the pipeline apparatus is employed. Representatively, a suitable diameter is on the order of two inches to 60 inches (51 mm to 1500 mm). A length dimension of pipeline apparatus 110A and pipeline apparatus 110B may also vary. Representative lengths are on the order of four feet to 48 feet (1.2 meters to 14.6 meters). It is appreciated that pipeline apparatus 110A and pipeline apparatus 110B may represent a series of individual pipeline apparatus connected together to form a desired composite or aggregate length or run. In another embodiment, system 100 may include one or more pipeline apparatus connected to a length of pipe or lengths of pipe to form a desired composite or aggregate length or run.

As shown in FIG. 1, each pipeline apparatus defines a conduit or duct having an opening therethrough from which material may flow into one end and out the other end. In some systems, it is desired to monitor conditions of a material flowing through a pipeline apparatus. In the embodiment shown in FIG. 1, system 100 includes device 120A and device 120B. In one embodiment, device 120A and device 120B are at least temperature sensors and may also include a flow rate sensor and/or pressure sensor. Device 120A and device 120B representatively include remote terminal units (RTUs) or programmable logic controllers (PLCs) connected to the sensors. RTUs or PLCs may, for example, convert sensor signals to digital data and transmit or make available digital data to controller 130. Controller 130 representatively includes machine-readable program instructions stored in a memory (e.g., non-transitory). When the machine-readable instructions are executed, such instructions perform operations including monitoring conditions in the pipeline apparatus and controlling systems. Representatively, controller 130 receives data, such as temperature data from devices 120A and 120B and may make adjustments based on such received data.

System 100 of FIG. 1 also shows device 125 connected to valve 115. Device 125 is also connected to controller 130. Device 125 may be used to actuate valve 115 in response to instructing from controller 130 to control the flow of material through pipeline apparatus 110A and pipeline apparatus 110B.

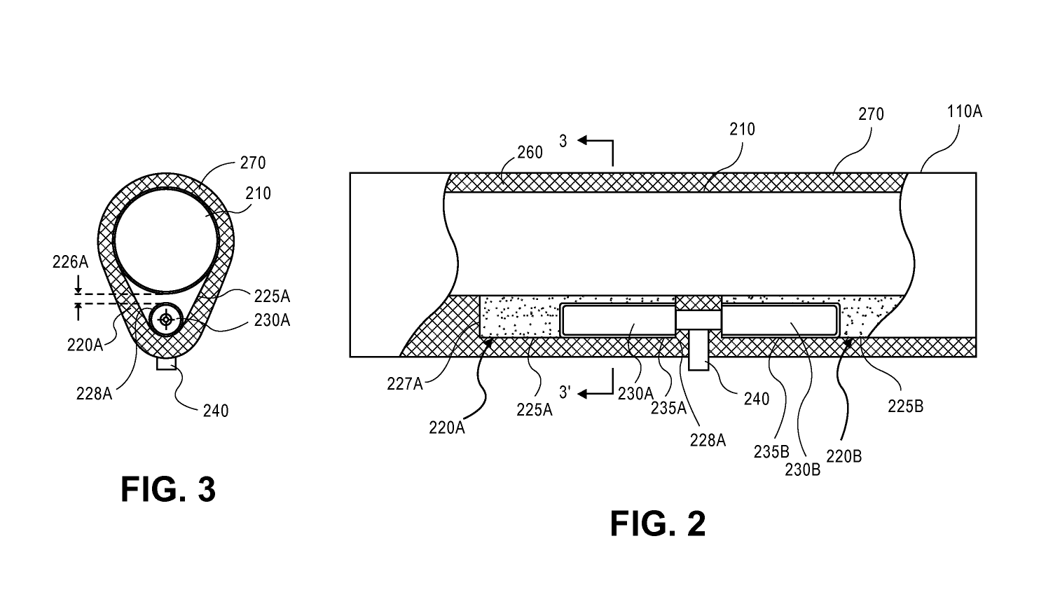

FIG. 2 shows a side view of a portion of pipeline apparatus 110A. FIG. 3 is a cross-section of the apparatus through line 3-3′ of FIG. 2. Pipeline apparatus 110A includes pipe or duct 210 that is, for example, a metal material such as steel. Pipe or duct 210 includes a wall that defines a transfer conduit through which material will flow into one end and out another end or some exit branch therebetween. As shown in FIG. 3, in one embodiment, pipe 210 has a circular cross-section. In other embodiments, a cross-section of pipe 210 can have a different cross-section shape. Connected to an external side of a wall of pipe 210 is a pair of thermally conductive compartments, thermally conductive compartment 220A and thermally conductive compartment 220B. In this embodiment, thermally conductive compartment 220A and thermally conductive compartment 220B are arranged symmetrically proximal end to proximal end. Each thermally conductive compartment includes, for example, a trough-like body (body 225A and body 225B, respectively) of a thermally conductive material such as steel wherein opposite sides of the trough-like body are connected in a tangential manner to an external side of the wall of pipe 210. Such connection is, for example, through a sealed weld connection. A base of the trough-shaped body narrows as the sidewalls converge to a rounded base. In one embodiment, trough-shaped body 225A and body 225B each has a length that extends a portion of the length of pipe 210, including the entire portion. Representatively, a length dimension of each thermally conductive compartment is less than a length dimension of pipe 210 (e.g., less than one-half a length of pipe, less then one-third a length of pipe).

Thermally conductive compartment 220A and thermally conductive compartment 220B are closed at each end to form a sealed chamber therein. A distal end is closed by a distal end cap that is, for example, a steel body welded to the sidewalls and base of body 225A and body 225B, respectively, and to pipe 210. FIG. 2 identifies distal end cap 227A of thermally conductive compartment 220A. In one embodiment, a proximal end includes a similar cap. In another embodiment, a proximal end cap is releasable (e.g., a pressure-fit cap). FIG. 2 identifies proximal end cap 228A of thermally conductive compartment 220A. The trough-shaped body and proximal and distal end caps define a volume or chamber. In one embodiment, the body and end caps and their connections to each other and to pipe 210 may be pressure tested to withstand, for example, a 1.5 millipascal (mPa) pressure test. Further, an inner surface defining the chamber or volume, in one embodiment, is free of burrs or other debris, or oil to provide a smooth, unvaried and clean surface.

As shown in FIG. 2 and FIG. 3, the connection of thermally conductive compartment 220A and thermally conductive compartment 220B to an exterior surface of a wall of pipe 210 defines a volume or chamber. Each volume or chamber is suitable to contain a heating element therein. FIG. 2 shows heating element 230A in a volume or chamber of thermally conductive compartment 220A and heating element 230B in a volume or chamber of thermally conductive compartment 220B. Each heating element, in one embodiment, is spaced from an exterior surface of a wall of pipe 210 by a gap, shown as gap 226A in FIG. 3 of an inch or more. In one embodiment, each heating element is an electrical heater cartridge with positive and negative terminals located at a single end. In one embodiment, such a cartridge has a representative length on the order of 300 millimeters or more. In another embodiment, a heating cartridge has a length on the order of 150 millimeters or less. In one embodiment, a volume or chamber of thermally conductive compartment 220A and of thermally conductive compartment 220B each include a thermally conductive sleeve or socket therein into which a heating element is inserted to isolate the heating element from other material in the volume or chamber. FIG. 2 shows sleeve or socket 235A in chamber 225A and sleeve or socket 235B in chamber 225B. Each sleeve or socket has an interior diameter and length suitable to accommodate a respective heating element therein. A representative material for each sleeve or socket is a metal such as steel. A sleeve or socket may be connected to a body of a thermally conductive compartment (e.g., body 225A, body 225B) by, for example, a weld connection. One advantage to containing a heating element in a sleeve or socket of a chamber of a thermally conductive compartment is that the heating element may be accessed such as to replace it without disturbing other contents in the chamber. Representatively, a proximal end cap (e.g., proximal end cap 228A) of a thermally conductive compartment (e.g., thermally conductive compartment 220A) includes an opening through which a heating element may be inserted into a sleeve or socket. In the example where a heating element is an electrical heating cartridge having positive and negative terminals at a proximal end, in one embodiment, the heating cartridge is inserted to such a length that such terminals remain accessible beyond the thermally conductive compartment.

As described above, in one embodiment, heating element 230A and heating element 230B are electrical heating cartridges (e.g., rods) with terminals on one end (e.g., a proximal end). The terminals are accessible at an exterior of a proximal end cap of each thermally conductive compartments 220A and 220B and are connected to cable 240. Electrical power (e.g., current) is supplied by cable 240 from a power source. In one embodiment, cable 240 used to supply power to each heating element (e.g., heating element 230A and heating element 230B) is a high temperature resistance fluoroplastics electric cable. Heating element 230A and heating element 230B are insulated which allows pipe 210 and a surface of thermally conductive compartment 220A and thermally conductive compartment 220B to not be charged. Grounding is done at the power supply connecting point and grounding resistance is representatively less than four watts, which ensures an electric potential at a transport pipeline is zero and it is safe and reliable.

In addition to a heating element, each volume or chamber of thermally conductive compartment 220A and thermally conductive compartment 220B includes a thermally conducting material or media. Thermally conductive material 250A and thermally conductive material 250B are present in thermally conductive compartment 220A and thermally conductive compartment 220B, respectively, in an amount sufficient to transfer heat from heat element 230A and heat element 230B to pipe 210. Suitable representative thermally conductive material 250 is described in U.S. Pat. Nos. 6,132,823; 6,911,231; 6,916,430; 7,220,365 and U.S. Patent Publication No. 2005/0056807, which are incorporated by reference herein. In another embodiment, thermally conductive material 250A and thermally conductive material 250B is an inorganic material that is a combination of oxides and one or more pure elemental species, particularly titanium and silicon. One such combination is provided in Table 1.

TABLE 1

| | |
|---|---|
| sodium peroxide | 2.705% |
| disodium oxide | 2.505% |
| silicon | 1.6% |
| diboron trioxide | 0.505% |
| titanium | 0.405% |
| copper oxide | 0.405% |
| cobalt oxide | 0.255% |
| beryllium oxide | 0.255% |
| water, distilled, conductivity or of similar purity | 89.256% |
| dirhodium trioxide | 1.6% |
| trimanganese tetraoxide | 0.255% |
| strontium carbonate | 0.255% |

In an embodiment using the thermally conductive material described in Table 1, the material is introduced into volume or chamber 225A of thermally conductive compartment 220A and volume or chamber 225B of thermally conductive compartment 220B in a representative range amount minus the water component, equivalent to 1/400,000 of the volume of the thermally conductive compartment. Other amounts may also be suitable such as an amount ranging from 1/400,000 to 1/200,000 by volume. For those thermally conductive materials described in the referenced incorporated patent documents, other amounts of thermally conductive material may also be used. For example, U.S. Pat. No. 7,220,365 describes an inorganic thermally conductive material of cobalt oxide, boron oxide, calcium dichromate, magnesium dichromate, potassium dichromate, beryllium oxide, titanium diboride and potassium peroxide in amounts of 0.001 to 0.025 by volume.

Without wishing to be bound by theory, it is believed that the thermally conductive material in each thermally conductive compartment operates by mechanically conducting heat generated by a heating element to pipe 210 (e.g., axially conducts heat). The spacing of the heating element from an exterior surface of the pipe (see gap 226A in FIG. 3) allows the heat generated in the thermally conductive compartment to be conducted to the pipe by the thermally conductive material yielding a homogeneous heat distribution. That heat, in turn, is transferred to a material in the pipe. The solid particles of the thermally conductive material collide with one another and with a wall of the thermally conductive compartment and pipe representatively generating an oscillation frequency on the order of 200 million hertz per second and using sine waves to conduct heat. This mechanism allows heat to evenly distribute along the surface of a pipe. Thus, what is described is a non-phase change inorganic thermal conducting technology that uses, in this embodiment, electricity as a heat source to directly provide energy to a pipeline. Its equivalent heat transfer efficiency is 14 MW/m° C., which is 30,000 times higher than silver. An axial heat flux density can reach 27 MW/m². An electrothermal conversion is on the order of 1 kW is 1500 kcal.

Referring again to FIG. 2 and FIG. 3, overlying/surrounding and connected to pipe 210 and thermally conductive compartment 220A and thermally conductive compartment 220B is a shell of insulating material. Shell 270 is, for example, a polyurethane foam material or other material having a representative coefficient of thermal conductivity on the order of 9.9 watt per meter per Kelvin (W/mK) to 0.02 W/mK. Shell 270 serves in one aspect to reduce thermal losses.

The technology described is adaptable to any short, medium and long distanced thermally conductive (e.g., metal) transportation liquid pipeline installed in any way and at any location, such as buried underground, underwater and ground overhead. It can also be used in fields, mines, factories, flammable and explosive locations and with storage containers. It is appreciated that a length and/or volume of a thermally conductive compartment connected to a pipe and therefore the amount of thermally conductive material therein will vary according to the environment and a material transported in a pipe or duct (transfer conduit). In the embodiment shown in FIG. 2, thermally conductive compartment 220A is illustrated as having a length substantially less than a length of half of pipe 210. Such a configuration will be sufficient in certain instances to heat a material in a pipe (e.g., pipe 210) or maintain a temperature of a material in the pipe. In other instances, a length of a thermally conductive compartment or compartments may extend an entire length of a pipe. In addition, the number and placement of an apparatus including a transfer conduit (e.g., a pipe or duct) and a thermally conductive compartment will vary according to factors such as an overall length of a transfer conduit, a diameter of a conduit (pipe), an amount of material being transported, a property of the material being transported, and environmental conditions. In other words, a pipeline may include sections including only pipe (e.g., insulated pipe) and other sections including a pipeline apparatus such as in FIG. 2 and FIG. 3 that includes a pipe, one or more thermally conductive compartments and insulation.

Representatively, a system including a controller, a transfer conduit (e.g., pipeline) with periodic pipeline apparatus including pipe/thermally conductive compartment(s), and periodic temperature sensors can be used to maintain a predetermined temperature of a material in the pipeline (transfer conduit) throughout its length. Referring to FIG. 1, for example, device 120A and device 120B include periodically spaced sensors. Device 120A and device 120B provide temperature data at two different points along a pipeline to controller 130. Controller 130 includes machine-readable instructions that determine whether the temperature data provided by the sensors is within an acceptable range for a material that is being transported through the pipeline. If the temperature is below a predetermined minimum temperature, the controller directs an increased output from one or more heating units in sections including a thermally conductive compartment along the pipeline by, for example, controlling the power supply to such heating units. If the temperature is above a predetermined maximum temperature, the controller directs a decreased output from one or more heating units along the compartment.

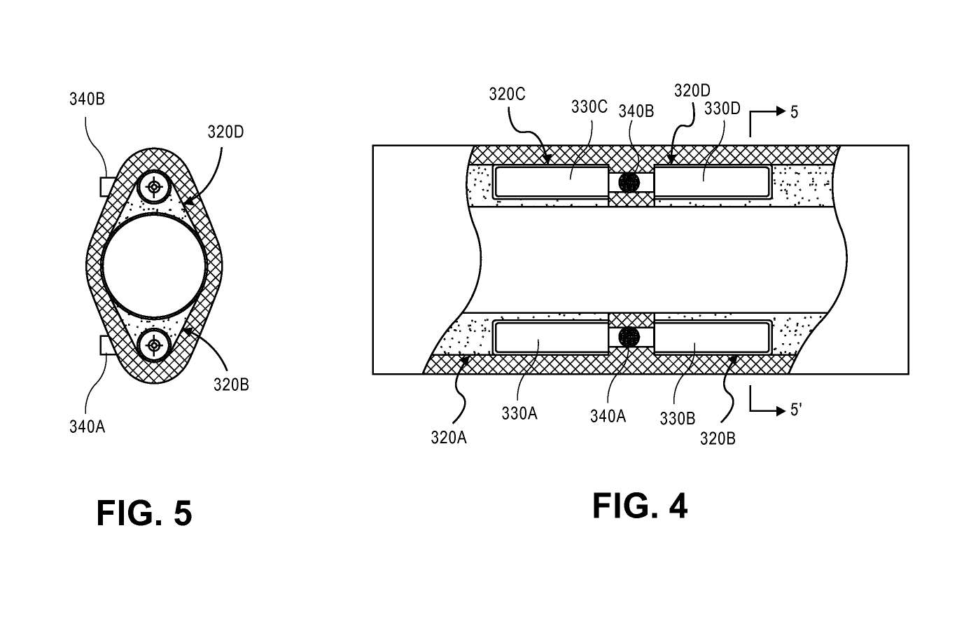

FIG. 4 shows a side view of another embodiment of a pipeline apparatus. FIG. 5 is a cross-section of the apparatus through line 5-5′ of FIG. 4. Pipeline apparatus 300, in this embodiment, includes pipe or duct 310 that is, for example, a metal material such as steel. Pipe 310 includes a wall that defines a transport conduit to which material will flow into one end and out the other end or some exit branch therebetween. Connected to an external surface of a wall of pipe 310 are two pairs of thermally conductive compartments. The first pair, thermally conductive compartment 320A and thermally conductive compartment 320B, are connected to one portion of pipe 310 and arranged proximal end to proximal end similar to the embodiment described with reference to FIG. 2. A second pair, thermally conductive compartment 320C and thermally conductive compartment 320D, are also connected to pipe 310 in a proximal end to proximal end arrangement. In one embodiment, thermally conductive compartment 320C and thermally conductive compartment 320D are connected to pipe 110 at an opposing side, such as 180 degrees separated from thermally conductive compartment 320A and thermally conductive compartment 320B.

In this embodiment, each thermally conductive compartment includes, for example, a trough-like body of a thermally conductive material such as steel with sides of a trough-like body connected in a tangential manner to pipe 310. Such connection is, for example, through a weld connection. A base of the trough-shaped body of each thermally conductive compartment narrows as the sidewalls converge to a rounded base. In one embodiment, the trough-shaped body of each thermally conductive compartment has a length that extends a portion of the length of pipe 310, including the entire portion. Proximal and distal end caps on each conductive compartment define a cavity or chamber therein.

As shown in FIG. 4 and FIG. 5, each thermally conductive compartment includes heating elements (heating element 330A, 330B, 330C and 330D) having positive and negative terminals accessible from a proximal end of the thermally conductive compartment. Each heating element is connected to a power cable (power cable 340A, power cable 340B). In addition to a heating element, each thermally conductive compartment includes a thermally conducting material disposed in a cavity or chamber.

In the embodiments described with reference to FIGS. 2-5, thermally conductive compartments are described that have a trough-like shape with one side of the compartment defined by an exterior surface of a wall of a pipe. In another embodiment, a thermally conductive compartment may have an alternative shape and/or be self-defined. Representatively, a thermally conductive compartment may have a cylindrical shape with a wall of the thermally conductive compartment connected to a wall of the pipe. The heat transfer in this embodiment will be through the wall of the thermally conductive compartment to the pipe.

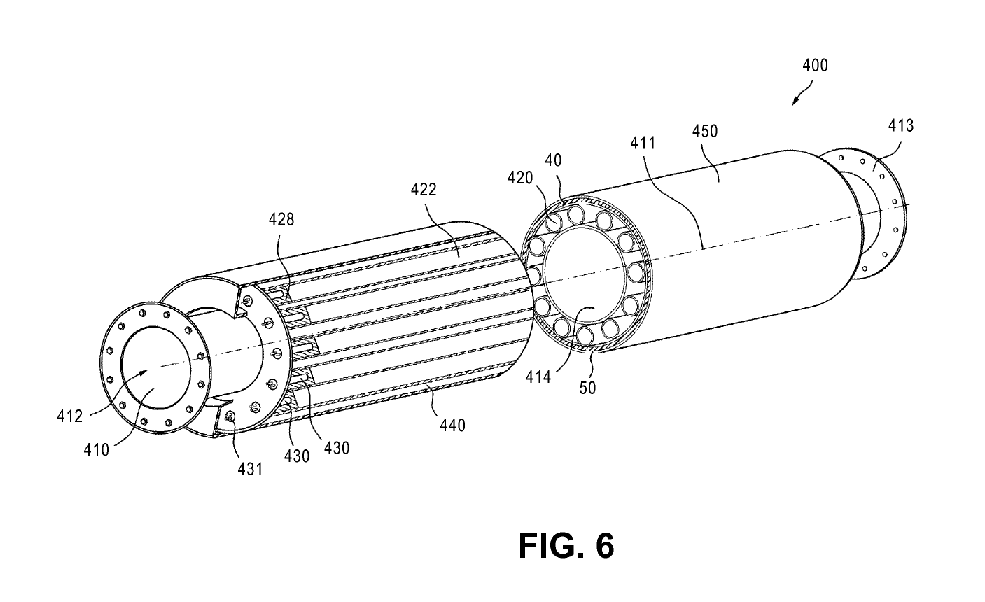

FIG. 6 shows a partially transparent isometric view of another embodiment of a pipeline apparatus. Pipeline apparatus 400 defines transfer conduit 412 formed by a wall of pipe or duct 410 of a metal material such as steel. Pipeline apparatus 400, in this embodiment, has a circular cross-section and is a segment of a pipeline. Pipe or duct 410 has at each of its distal ends, a flange (flange 413) for connecting pipeline apparatus 400 as a segment to other segments.

Pipeline apparatus 400 also includes a heating portion, being covered by a housing. Housing 450 surrounds pipe or duct 410. Inside housing 450 are compartments 420 (12 shown) that are capable of being heated by heating elements 430. Each compartment 420 is a tubular structure of a thermally conductive material such as steel that extends longitudinally along a portion of a length of pipe or duct 410 including from one flange to the other. Inside each compartment is a heating element (heating element 430) and a thermally conductive material such as described above. Each heating element 430 is, for example, an electrical heating cartridge that provides heat to its respective compartment 420. Such heat is conducted by thermally conductive material to pipe or duct 410.

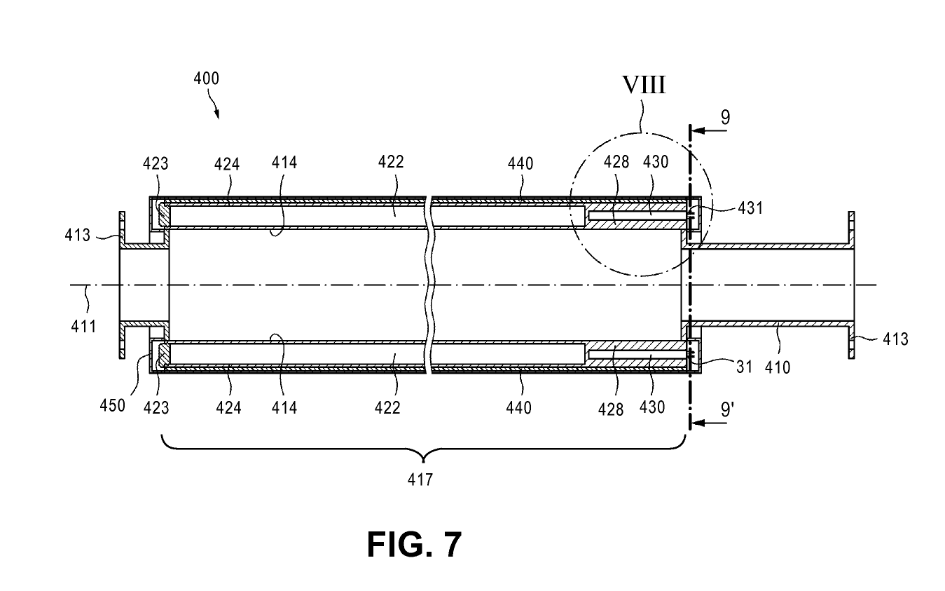

FIG. 7 shows a longitudinal section of the pipeline apparatus in FIG. 6. Pipeline apparatus 400 includes pipe or duct 410 configured to transport a material from one end to another. Pipe or duct 410 is defined by duct wall 414. Pipe or duct 410 has heating section 417 with, in this embodiment, optional step like extended diameter.

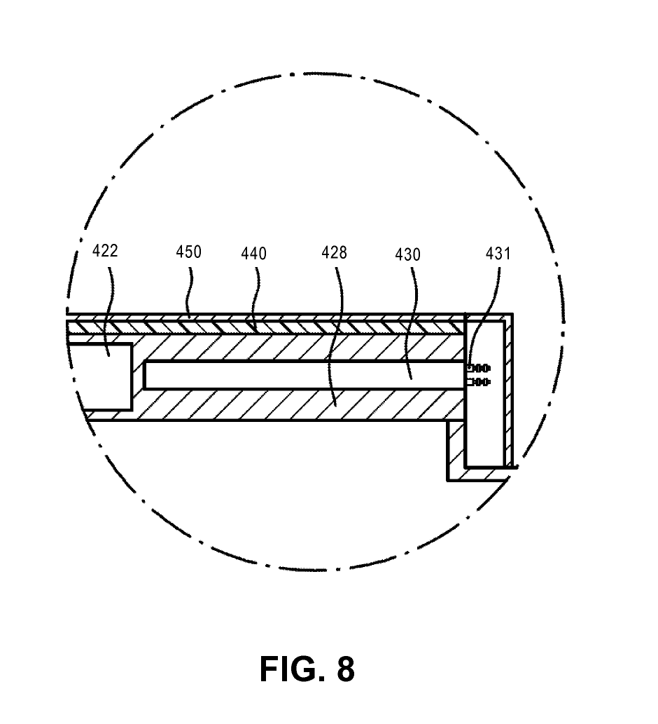

On the peripheral surface of heating section 417 of pipe or duct 410 are compartments 470. Each compartment 520 is a tubular structure defined by compartment wall 424 that is connected to wall 414 of pipe or duct 410 by, for example, a weld connection. In this embodiment, each compartment 420 has a cylinder axis, which is parallel to axis 411 of pipe or duct 410. The distal ends of each compartment 420 are closed, one end by end cap 423, the other by sleeve section 428. A connection of end cap 423 to compartment wall 424 may be a relatively permanent connection such as a weld connection while the connection sleeve 428 to compartment wall may be removable (e.g., a threaded connection). As shown in FIG. 8, sleeve section 428 has a sleeve like distal opening, into which heating element 430 (e.g., an electrical heating cartridge) is inserted. Compartment wall 424 is surrounded by insulation wall 440, which again is surrounded by a housing 450.

FIG. 8 shows a detail of sleeve section 428. The electrical heating element 430 that is an electrical heating cartridge can be connected via terminals 431 to a power supply as described above.

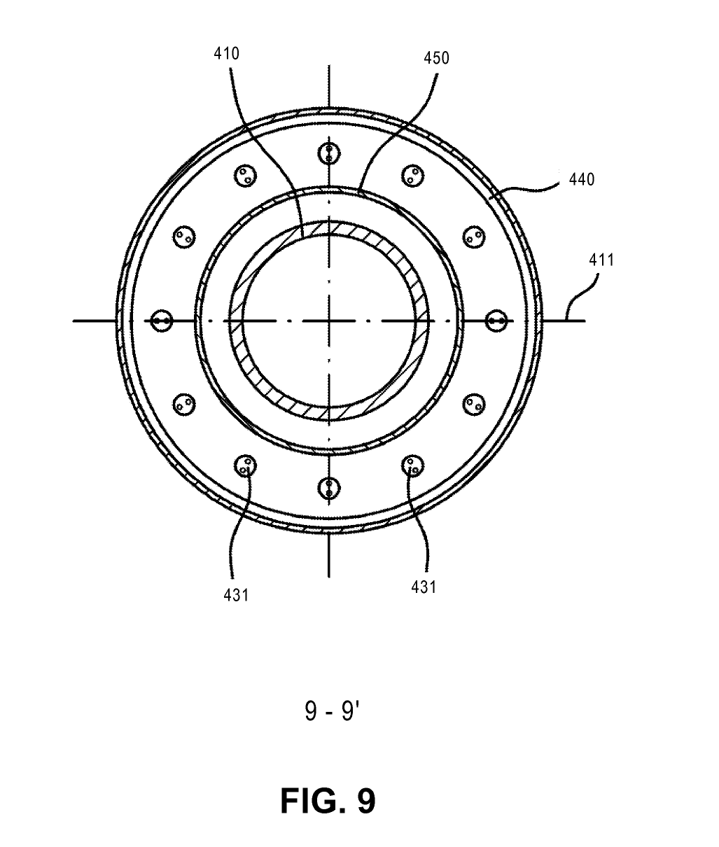

FIG. 9 shows a cross-section through line 9-9′ as indicated in FIG. 8. Heating elements 430 are arranged symmetrically with respect to pipeline apparatus 400 longitudinal axis 411.

In the description above, for the purposes of explanation, numerous specific details have been set forth in order to provide a thorough understanding of the embodiments. It will be apparent however, to one skilled in the art, that one or more other embodiments may be practiced without some of these specific details. The particular embodiments described are not provided to limit the invention but to illustrate it. The scope of the invention is not to be determined by the specific examples provided above but only by the claims below. In other instances, well-known structures, devices, and operations have been shown in block diagram form or without detail in order to avoid obscuring the understanding of the description. Where considered appropriate, reference numerals or terminal portions of reference numerals have been repeated among the figures to indicate corresponding or analogous elements, which may optionally have similar characteristics.

It should also be appreciated that reference throughout this specification to “one embodiment”, “an embodiment”, “one or more embodiments”, or “different embodiments”, for example, means that a particular feature may be included in the practice of the invention. Similarly, it should be appreciated that in the description various features are sometimes grouped together in a single embodiment, figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

What is claimed is:

1. An apparatus comprising:
a transfer conduit having a length and an opening therethrough;
at least one thermally conductive compartment coupled to an exterior surface of the transfer conduit, the at least one thermally conductive compartment having a length dimension that extends over a portion of the length of the transfer conduit;
a heating element disposed in a portion of the at least one thermally conductive compartment; and
a thermally conducting material disposed in the thermally conductive compartment.

2. The apparatus of claim 1, further comprising an insulating material on the transfer conduit and the at least one thermally conductive compartment.

3. The apparatus of claim 1, wherein the heating element is an electric heating element.

4. The apparatus of claim 1, wherein the at least one thermally conductive compartment comprises at least a pair of thermally conductive compartments each with an end and a respective heating element disposed in the end, and the pair of thermally conductive compartments are arranged end to end on the transfer conduit.

5. The apparatus of claim 4, wherein the at least a pair of thermally conductive compartments comprises a first pair, and the apparatus comprises a second pair of thermally conductive compartments on another portion of the exterior of the transfer conduit.

6. The apparatus of claim 5, wherein the first pair of thermally conductive compartments and the second pair of thermally conductive compartments are coupled to opposite sides of the transfer conduit.

7. The apparatus of claim 1, wherein the at least one thermally conductive compartment comprises a volume and the heating element is disposed in less than the entire volume, and the thermally conducting material in thermally conductive compartment is present in amount that is less than the remaining volume.

8. The apparatus of claim 1, wherein the thermally conducting material is a combination of the following substances:
sodium peroxide;
disodium oxide;
silicon;
diboron trioxide;
titanium;
copper oxide;
cobalt oxide;
beryllium oxide;
dirhodium trioxide;
trimanganese tetraoxide;
strontium carbonate;
one or more species having a corrosion inhibition element;
one or more species having an activation element; and
one or more species having a heat conducting element.

9. A method comprising:
transferring a fluid through a transfer conduit comprising at least one thermally conductive compartment coupled to an exterior surface thereof, the at least one thermally conductive compartment having a length dimension that extends over a portion of a length dimension of the transfer conduit and comprising a heating element and a thermally conducting material disposed therein; and
providing a power source to the heating element sufficient to increase the temperature of the thermally conductive compartment.

10. The method of claim 9, wherein the fluid is a liquid.

11. The method of claim 9, wherein the fluid comprises oil.

12. A system comprising:
a transfer conduit having a length between a first point and a second point and an opening therethrough;
at least one thermally conductive compartment coupled to an exterior surface of the transfer conduit, the at least one thermally conductive compartment having a length dimension and comprising a heating element and a thermally conducting material disposed therein; and
a power source coupled to the heating element.

13. The system of claim 12, further comprising at least one temperature sensor coupled to the transfer conduit configured to measure a temperature of a fluid in the transfer conduit.

14. The system of claim 12, further comprising a controller coupled to the at least one temperature sensor and the power source, the controller comprising machine readable instructions configured to regulate an amount of heat delivered by the at least one heating element.
